(19) United States
(12) Patent Application Publication
(10) Pub. No.: US 2025/0319471 A1
(43) Pub. Date: Oct. 16, 2025

(54) RECTANGULAR SHAPED PIPETTE TIP CARRIER FOR HOLDING A PLURALITY OF PIPETTING TIPS

(71) Applicant: Tecan Trading AG, Männedorf (CH)

(72) Inventors: Giuseppe GUGLIOTTA, Altendorf (CH); Walter STEINHAUER, Männedorf (CH); Adrian SAGER, Männedorf (CH)

(73) Assignee: Tecan Trading AG, Männedorf (CH)

(21) Appl. No.: 19/083,222

(22) Filed: Mar. 18, 2025

(30) Foreign Application Priority Data
Apr. 11, 2024 (EP) 24169583.2

(51) Int. Cl. B01L 9/00

(52) U.S. Cl. CPC B01L 9/543; B01L 2200/025; B01L 2300/0809

(57) ABSTRACT

A rectangular shaped pipette tip carrier comprising a rectangular shaped top plate, a peripheral wall surrounding the top plate and connecting the top plate to a rectangular skirt vertically distanced from the top plate, a plurality of vertically oriented hollow cylinders defining a matrix of passages through the pipette tip carrier for detachably holding disposable pipette tips, a plurality of ribs connecting the hollow cylinders to another and a plurality of skirt ribs connecting the top surface of the rectangular skirt to the peripheral wall. The carrier further comprises at least one opening in the longitudinal side or the transverse side of the rectangular skirt providing a passage for a protrusion of a packaging or a passage for a protrusion of a spacer configured to be positioned on top of the pipette tip carrier.

### CROSS REFERENCE TO RELATED APPLICATIONS

This application claims priority to European Patent Application EP24169583.2, filed Apr. 11, 2024, entitled “A RECTANGULAR SHAPED PIPETTE TIP CARRIER FOR HOLDING A PLURALITY OF PIPETTING TIPS”, which is incorporated by reference herein in their entirety and for all purposes.

### TECHNICAL FIELD

The current disclosure relates to a rectangular shaped pipette tip carrier for holding a plurality of tips for use in a pipetting apparatus.

### BACKGROUND

In chemical, biological, pharmaceutical, and similar laboratories, small liquid volumes are typically received and discharged using pipettes. Automated liquid handling platforms are frequently used for this purpose, which enable the aspirating and/or dispensing of liquid volumes with high precision and, nonetheless, high throughput rates for the liquid samples. Such liquid handling platforms very often include pipetting robots, which are equipped with disposable or single-use pipette tips to avoid contamination between processing and sample liquids. Liquid handling platforms are typically charged with such disposable or single-use pipette tips, in that carrier plates equipped with pipette tips or even stacks of such carrier plates are provided. Such carrier plates typically include arrays of pipette tips arranged in a standardized matrix so that a pipetting head of a pipetting robot can receive one or more of these pipette tips. Multichannel pipetting heads of the pipetting robot can collect one or more rows of pipettes from the carrier plate by coupling each of the pipetting heads to the pipettes. A collar adapter on the pipetting head pushes onto the collar of the pipette tips and thereby applies a vertical load onto the pipette carrier. The pipettes are disposed after use leading to an increased demand of disposable pipette tips which need to be stored within the pipetting robot. Space saving solutions have been developed for the storage of the disposable tips.

Carrier plates for disposable pipette tips and stacks of such carrier plates having inserted pipette tips are known from the prior art. EP2210668A2 discloses a storage system which includes a rectangular box and a rectangular pipette carrier plate having a plurality of holes arranged in a matrix for the insertion of pipette tips. The pipette carrier plate can be placed on top of the rectangular box such that the space in the box is available for the pipette tips extending through the holes of the carrier plate. Spacers are disclosed for building an alternating stack including multiple pipette carrier plates each separated by a spacer. Using multiple carrier plates and multiple spacers leads to a space saving and nested arrangement of the pipette tips whereby the vertical load, for example during the collection of the pipette tips by the pipetting head of the pipetting robot is repetitively transferred from the edge of each carrier to the spacer according to a spacer-to-carrier load principle. The pipette carrier is constructed as multiple holes penetrating a monoblock of material to increase the mechanical strength of the carrier for transferring the vertical load from the center of the pipette carrier to the edges. Longitudinal rims at least partially surround the carrier for handling and gripping the carrier by the pipetting robot.

US20170008001A1 discloses a pipette tip rack with a bottom and base side walls protruding vertically from the bottom. A plurality of cylinder bores for holding pipettes penetrate the bottom and the cylinders are interconnected to another by ribs or are connected to the base side wall surrounding the plurality of cylinders using ribs. Vertical buttresses provide mechanical support between the bottom and base side walls on the longitudinal and transverse sides of the rectangular rack.

### SUMMARY OF THE INVENTION

The alternating load transfer from a pipette carrier to a spacer requires that both the spacer and the pipette carrier need to be manufactured with low dimensional tolerances to reduce the stack-up of multiple tolerances that may affect effective transfer of vertical loads and proper alignment. Pipette carriers allowing for spacer-to-spacer loading may be preferred. Furthermore, the vertical loads during pick-up of the pipettes are transferred to the spacer via the edges and corners of the carriers requiring a stiff and material demanding construction of the pipette carrier along both sides of the carrier and within the corner sections. The carriers according to the prior art may have an increased carbon footprint as they require more plastic material in their construction.

It is an objective of the present disclosure to overcome the disadvantages of the prior art and to provide pipette carriers which are mechanically strong and require less material or reduce the carbon footprint. Furthermore, pipette tip carriers are provided configured for spacer-to-spacer loading.

Those objectives are solved by the independent claims, further exemplary embodiments are evident from the dependent claims and the following description including the Figures.

In an aspect of the disclosure, a rectangular shaped pipette tip carrier is disclosed for holding a plurality of disposable tips for use in a pipetting apparatus. The pipette tip carrier includes a rectangular shaped top plate defining a horizontal plane surrounded by a rectangular shaped peripheral wall connecting the top plate to a rectangular skirt or rim. The rectangular skirt is vertically distanced from the top plate and surrounds the peripheral wall and is oriented essentially parallel to the horizontal plane. The rectangular skirt extends from the peripheral wall outwards or towards the center of the rectangular shaped pipette tip carrier. A plurality of vertically oriented hollow cylinders or holes extend from the top plate towards the bottom surface of the rectangular skirt and a plurality of circular openings in the top plate is aligned with the plurality of hollow cylinders thereby defining a matrix of passages through the pipette tip carrier for detachably holding and guiding disposable pipette tips. A plurality of ribs, so called inter-cylinder ribs, are provided connecting the hollow cylinders to another and/or a plurality of ribs, so called wall-ribs, may be located between and connecting the hollow cylinders to the peripheral wall. The thickness of the inter-cylinder ribs may be constant or variable depending on the position within the carrier. The inter-cylinder ribs may, for example have a thicker wall in the center of the pipette tip carrier compared to the inter-cylinder ribs that are closer to the peripheral wall. Preferably there is an open space between the ribs and/or the cylinders such that less material is needed. The ribs are preferably oriented perpendicular to the horizontal plane. Alternatively, there is an intersection of the outer surfaces of the plurality of cylinders directly connecting the cylinders to another or to the peripheral wall. The pipette tip carrier furthermore includes a plurality of skirt ribs or buttresses connecting the top surface of the skirt to the peripheral wall.

The skirt ribs preferably connect the horizontally oriented top surface of the rectangular skirt to the vertically oriented peripheral wall. The skirt ribs are preferably oriented perpendicular to the horizontal plane and may have a triangular shape.

At least one opening is included in the longitudinal side or the transverse side of the rectangular skirt providing a passage for a complementary protrusion of a packaging for the pipette tip carrier or a passage for a complementary protrusion of a spacer configured to be positioned on top of the pipette tip carrier.

The space available on the peripheral wall between the skirt ribs may be used for labelling or coding the product, for example using a bar code or QR-code. The thickness or stiffness of the skirt ribs may be constant or may vary depending on the location on the pipette tip carrier for a design that is adapted to the distribution of mechanical stresses across the carrier during vertical loading.

The pipette tip carrier is optimized with respect to mechanical stiffness and therefore includes the ribs between the cylinders thereby reducing the material used for the pipette tip carrier compared to a monoblock design for the carrier where holes penetrate a massive plate. There may be an open space between the cylinders or between the cylinders and the peripheral wall thereby reducing the amount of material used during, for example, injection molding.

The rectangular skirt is preferably thin compared to the vertical height of the pipette tip carrier and positioned at the distal end of the peripheral wall allowing easy access for a pipetting head of the robot and allowing for pick-up of single arrays of pipetting tips and avoiding a collision between the pipetting head and the top surface of the skirt. Furthermore, missing rows of pipettes may be detected by the firmware of the pipetting robot in a system including the pipetting robot and the pipette tip carrier with a thin-walled skirt section.

The openings in the skirt which are adapted to be complementary to the protrusions prevent relative rotation or horizontal movement between the carrier and a spacer engaging the carrier or horizontal movement between the carrier and a packaging engaging the carrier.

The rectangular shaped pipette tip carrier may further include openings at each corner of the rectangular shaped skirt providing a passage for complementary protrusions on a spacer configured to be positioned below or subjacent to the pipette tip carrier. The corner openings may be provided in the rectangular skirt of the pipette tip carrier. The openings at the corner may be part of the openings in the transverse or longitudinal side of the rectangular skirt or may be separate from the openings in the transverse or longitudinal sides. The corner openings may be circular, rectangular or triangular shaped opening. A mechanically supporting rim may surround each opening and this rim may include a facet facilitating the insertion of the complementary protrusion on the subjacent carrier during placement.

The rectangular shaped pipette tip carrier may further include corner ribs connecting the openings or the ribs surrounding the openings on each corner to the corners of the rectangular shaped peripheral wall. The corner ribs preferably extend vertical from the top surface of the peripheral wall and provide a buttress for the corner section of the pipette tip carrier. The corner ribs may have a right-angled triangular shape with one side connected to the top surface of the horizontal skirt and the other side connected to the vertical peripheral wall.

The corner ribs reinforce the corner sections of the pipette tip carrier when vertical loads are applied to the by the pipetting robot. The corner ribs may also prevent warpage of the pipette tip carrier such that the pipette tip carrier remains flat.

The rectangular shaped pipette carrier wherein the passages for holding the pipette tips provide a matrix of rows and columns evenly distributed across the rectangular shaped top plate. The matrix may be organized according to an ANSI/SLAS standard.

The center of the rectangular shaped top plate may be on top of and horizontally aligned with the center of the rectangular skirt for a mirror symmetric arrangement of the plurality of passages within the pipette tip carrier. The plurality of passages is organized according to arrays and columns and the matrix of the passages is symmetrically positioned within the rectangular shaped pipette tip carrier. A symmetric arrangement may facilitate easy pick-up of the pipetting tips as the approach for the pipetting robot is identical from each side of the carrier.

Alternatively, the center of the rectangular shaped top plate is horizontally shifted with respect to the center of the rectangular skirt for an asymmetric arrangement of the matrix of passages within the rectangular shaped carrier. An asymmetric arrangement may facilitate the intermeshing of the pipetting openings of pipetting tips facing each other, for example in a packaging with two pipetting carriers with bottom surfaces that face each other.

The end of the hollow cylinders that penetrate from the top surface of the pipette top carrier may be flush with the bottom surface of the rectangular skirt. The cylinders do not extend beyond the bottom surface of the rectangular skirt such that no additional material is used for the cylinders. Alternatively, the ends penetrate beyond the bottom surface as the penetrating part of the cylinders with their connecting ribs may provide for additional mechanical stability.

An additional bottom wall may extend vertically from the bottom surface of the rectangular skirt. The bottom wall preferably surrounds the matrix of the ends of the cylinders. The bottom wall may mechanically reinforce the pipette tip carrier against bending during vertical loading from on the top surface. The bottom wall may be configured for stacking the pipette tip carriers on top of each other.

The bottom wall extending from the bottom surface may include least one snap-fit connector or guiding member. The snap-fit connector may be compatible with a counterpart on a pipette box, a transport carrier, a packaging or a spacer or on another pipette tray for releasable connecting the parts during use in the pipetting robot or during transport. The guiding member may be used to hold or grip the pipette tip carrier or guide a gripper of the pipetting robot for gripping the carrier. Alternatively, the guiding member supports the alignment of the pipette tip carriers when pipette tip carriers are stacked on top of each other.

The rectangular skirt of the carrier may further include at least one cut-out in the longitudinal side or the transverse side of the rectangular skirt not having the at least one opening. The cut-out may provide space for protrusions or posts extending from a packaging for releasable fixating the carrier to the packaging or for facilitating the spacer-to-spacer vertical load transfer. The cut out may avoid that vertical loads are transmitted to the carrier.

The at least one opening in the skirt surrounding the peripheral wall of the pipette carrier may have a rectangular shape. The size of the rectangular opening allows for sufficient play for the complementary protrusions, or vice versa the protrusion allows for sufficient play with respect to the opening. The rectangular shaped opening may have rounded corners or may be mechanically strengthened by a rim surrounding the rectangular shaped opening.

The rectangular skirt surrounding the peripheral wall may include two openings positioned each on one of the two opposing longitudinal sides, or two openings positioned each on one of the two opposing transverse sides wherein the two opposing openings provide two passages for two protrusions of a packaging for the pipette tip carrier or for two protrusions of a spacer configured to be positioned on top of the pipette tip carrier.

The pipette carrier may be manufactured by injection molding of a polymer, a polymer compound, paper, cellulose or a cellulose derivative.

The polymer may be a recycled polymer or a biopolymer selected from polystyrene (PS), polycarbonate (PC), high impact polystyrene (HIPS), polyethylene (PE) or polypropylene (PP). Using recycled polymers, biopolymers or cellulose reduces the carbon footprint for the product.

These and other aspects of the invention will be apparent from and elucidated with reference to the embodiments described hereafter.

### BRIEF DESCRIPTION OF THE DRAWINGS

Embodiments of the present disclosure are described in more detail with reference to the attached drawings presenting:

FIG. 1: Perspective view from the top for a pipette tip carrier according to the present disclosure,

FIG. 2: Perspective view from the bottom for a pipette tip carrier according to the present disclosure,

FIG. 2a: Bottom view for a pipette tip carrier according to another embodiment,

FIG. 3: Detail of a corner section of the pipette tip carrier holding pipettes and a gripper of a pipetting robot,

FIG. 4a: Detail for a thin rectangular skirt section of the pipetting carrier allowing for pick-up of the first row of pipetting tips using the pipetting robot,

FIG. 4b: Detail for a medium thickness rectangular skirt section of the pipetting carrier allowing for pick-up for the first row of pipetting tips using the pipetting robot,

FIG. 4c: Detail for a high thickness rectangular skirt section of the pipetting carrier preventing pick-up of the first row of pipetting tips using the pipetting robot due to a collision of the collar adapter of a pipetting head with the skirt before pick-up of the pipette tips,

FIG. 4d: Detail for thin rectangular skirt section of the pipetting carrier allowing missing tip detection in the carrier,

FIG. 4e: Detail for rectangular skirt section of the pipetting carrier not allowing detection of missing tip due to a hard stop of the collar adapter on the skirt of the carrier,

FIG. 5: Packaging for the pipette tip carrier presented in FIGS. 1 and 2 in an unfolded configuration,

FIG. 6: Folded packaging for the pipette tip carrier presented in FIGS. 1 and 2,

FIG. 7: Packaging holding two pipette tip carriers,

FIG. 8: Longitudinal section of the packaging presented in FIG. 7,

FIG. 9: Perspective top view for a spacer for the pipette tip carrier presented in FIGS. 1 and 2,

FIG. 10: Perspective bottom view for a spacer for the pipette tip carrier,

FIG. 11: Exploded view of two spacers with three pipette tip carrier positioned there between,

FIG. 12: Stack of pipette tip carriers and spacers,

FIG. 13: Longitudinal section of the stack of FIG. 12,

FIG. 14: Detail for the corner section of the stack,

FIG. 15: Detail for spacer-to-spacer stacking via spacer protrusions and openings in the longitudinal skirt section of the pipette tip carrier,

FIG. 16: Detail for the corner section, cross sectional view.

### DETAILED DESCRIPTION OF EXEMPLARY EMBODIMENTS

Definitions: The distal end or distal direction is defined by the flow direction for the liquid, thus the distal tip of a pipette is defined by the outlet of the pipette tip and the proximal end is opposite to the distal end. The term subjacent means underlying or below; the term superjacent means lying above or on-top. In the claims, the word “comprising” does not exclude other elements or steps, and the indefinite article “a” or “an” does not exclude a plurality. For example. “an opening” does not exclude the fact that there may be two openings that functionally or structurally fulfill the purpose of “an opening”.

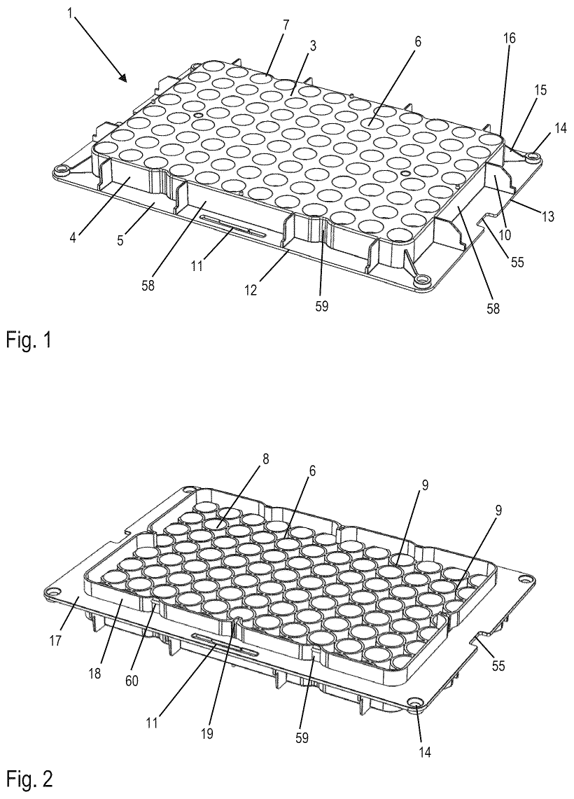

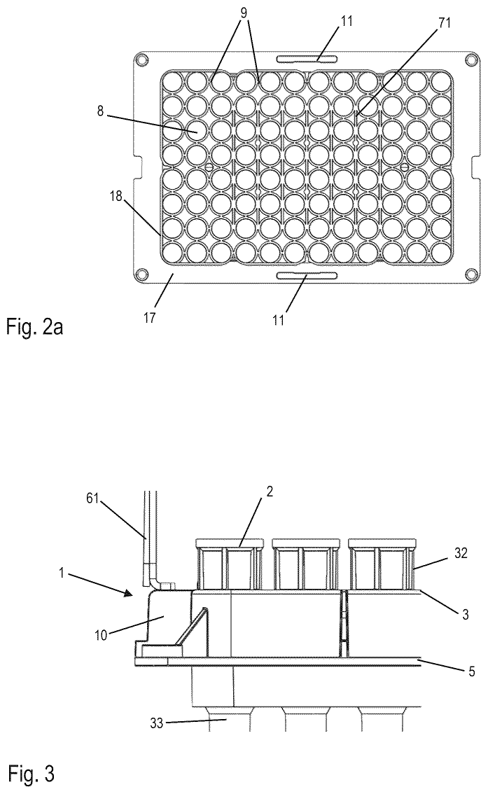

Perspective top and bottom views for a pipette tip carrier 1 according to an embodiment of the disclosure are presented in FIGS. 1 and 2, respectively. The pipette tip carrier 1 has a rectangular outer shape with a rectangular shaped top plate 3 surrounded by a peripheral wall 4 which connects the top plate 3 to a rectangular skirt 5. The top plate 3 defines a horizontal plane and the rectangular skirt 5 is oriented horizontal as well. The top plate 3 includes a plurality of circular openings 7 which are organized in a matrix of rows and columns according to ANSI/SLAS Microplate Standards, for example according to the 96 well-plate standard (ANSI SLAS 4-2004 (R2012): Well Positions). Hollow cylinders 6 depend from, or start at the circular openings 7 providing a matrix of passages 8 through the pipette tip carrier 1. The pipette tip carrier may releasably hold disposable pipette tips 2 using the passages 8 (see FIG. 3). The peripheral wall 4 may include a labelling section 58 for printing information such as the brand name or a two- or three-dimensional barcodes for identification or logistic purposes. The peripheral wall 4 may further include indentions 59. The rectangular skirt 5 includes a longitudinal side 12 and a transverse side 13 and is relative thin for a material saving product. The thickness of the skirt is below 3 mm, preferably below 2 mm, more preferably below 1.5 mm. The relatively thin rectangular skirt 5 is strengthened by a plurality of rim ribs 10 connecting the top surface of the rectangular skirt 5 to the peripheral wall 4. The rim ribs 10 furthermore provide guidance to and limit the horizontal play for a lid that may be placed on top of the pipette tip carrier 1. The top surface of the rim ribs 10 may be used for mechanically detecting the presence of the pipette tip carrier by a gripper of a pipetting robot. The space between two rim ribs 10 on the peripheral wall or on the top surface of the skirt 5 may provide for the labelling section 58. The rectangular skirt 5 includes openings 14 at each corner of the pipette tip carrier which are adapted to engage complementary protrusions of a spacer that will be placed below the pipette tip carrier as will be discussed further below. Alternatively, the openings 14 engage protrusions of a pipetting box that is fixated on the working table of the pipetting robot. A circular rim may surround each opening 14 providing an entrance section, for example a facetted rim, for guiding the protrusions during stacking of the spacers and the pipette tip carriers. The circular rim may further locally strengthen the rectangular skirt 5 in the corner section. The openings 14 may be dimensioned that there is horizontal play between the opening 14 and the protrusion of the spacer or there may be a friction fit engagement between the outer surface of the protrusion and the inner surface of the opening 14. The form-fit engagement may enable the temporary transport of an assembly of a spacer and a carrier via gripping the carrier only. Preferably, only the spacer is gripped by the pipetting robot, either in a form fit or friction fit engagement.

A corner rib 15 may connect the opening 14 or the circular rim surrounding the opening 14 to the peripheral wall 4, preferably to the corner 16 of the peripheral wall. The rectangular skirt 5 may further include at least one opening 11, preferably two openings 11 penetrating the two longitudinal sides 12 or the two transverse side 13 of the skirt. The opening 11 may have a rectangular, circular or triangular shape and provide a passage for a complementary protrusion of a superjacent spacer. The corners of the opening may be rounded and the edges of the opening may include a facet. The opening 11 may be surrounded by a rim for mechanically supporting the rectangular skirt 5 surrounding the opening 11. The rectangular skirt 5 may include a cut out 55 providing a passage for a protrusion of a superjacent spacer.

The pipette tip carrier 1 may include a bottom wall 18 vertically extending from the bottom surface 17 of the rectangular skirt 5. The bottom wall 18 surrounds the matrix of the passages 8 and the ends of the cylinders 6 providing the passages 8 are preferably even or flush with the bottom surface 17 of the rectangular skirt 5. Alternatively, the cylinders penetrate beyond the bottom surface 17 although further extension of the cylinders beyond the bottom surface 17 may lead to unnecessary use of material. The further extension of the cylinders may mechanically reinforce the pipette tip carrier. The cylinders 6 may be directly connected to neighboring cylinders by connecting ribs 9 to mechanically strengthen the pipette tip carrier. The cylinders 6 may also intersect to neighboring cylinders without using the connecting ribs 9 and the cylinders 6 may be connected to an inner surface of the peripheral wall 4 by connecting ribs or, as presented in FIG. 2, the cylinders may intersect with the inner surface of the peripheral wall 4. The thickness of the ribs may vary depending on the position within the pipette tip carrier according to the local needs defined by the mechanical stresses in the carrier upon vertical loading. The ribs 9 may be thicker in the center of the carrier compared to the ribs in the outer regions towards the skirt 5.

The indentions 59 on the bottom wall 18 of the carrier may include horizontal ridges 60 that may act as a vertical place holder for stacking multiple carriers or may provide a snap-fit connector between two carriers or between a carrier and a patent box. The guiding member 19 on the bottom wall 18 may be used for self-alignment purposes or gripping purposes. The guiding member 19 of the pipette tip carrier may self-align the carrier when positioned, for example on a pipetting box. The indention 59 with the ridge 60 may snap-fit the pipette tip carrier on a pipetting box or on a spacer. The indentions 59 and/or the guiding members 19 may locally strengthen the bottom wall 18.

An alternative embodiment for the pipette tip carrier is presented in FIG. 2a. The view on the bottom surface 17 presents the two openings 11 in the skirt of the carrier and the bottom wall 18 penetrating from the bottom surface 17. The plurality of passages 8 for the pipette tips are surrounded by the cylinders which are connected to another by connecting ribs 9. The embodiment presented in FIG. 2a is additionally mechanically supported by reinforcement ribs 71 connecting two connecting ribs 9 to another providing vertically oriented reinforcement ribs. The reinforcement ribs 71 are vertically oriented in FIG. 2a and oriented parallel to the transverse side of the pipette tip carrier. Alternatively, the reinforcement ribs are horizontally oriented parallel to the longitudinal side of the pipette tip carrier. In yet another embodiment there are both horizontally and vertically oriented reinforcement ribs 71.

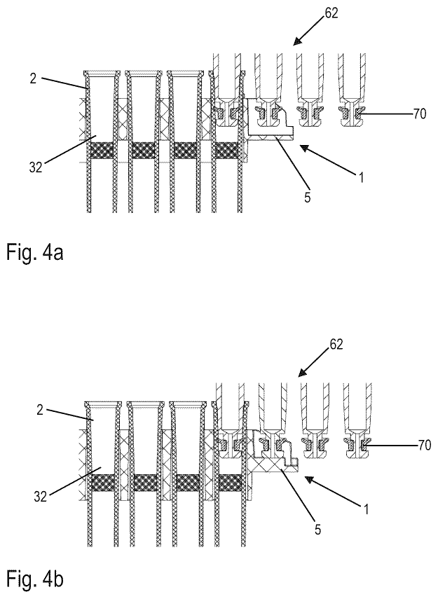

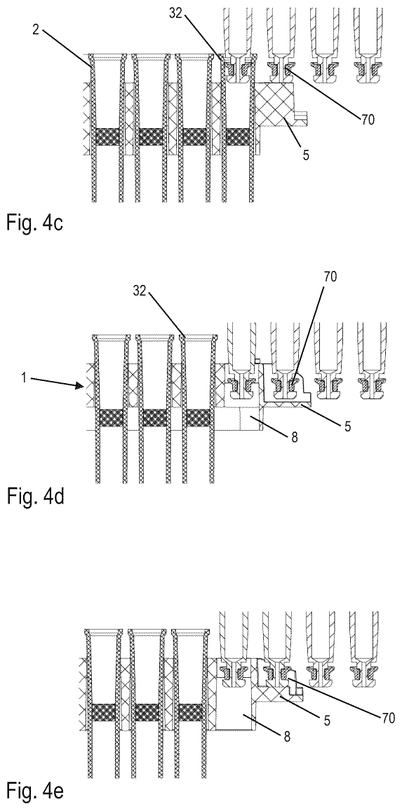

A detail of a corner section of the pipette tip carrier 1 holding pipettes 2 is presented in FIG. 3. The pipettes 2 include a collar 32 engaging the top plate 3 of the carrier and pipette tubes 33 extending from the collar 32 through the passages. A gripper 61 of a pipetting robot abuts the top surface of a rim rib 10, for example to mechanically detect if a tray is present or not. The pipetting robot may include a pipetting head 62 for collecting the pipetting tips 2, see FIGS. 4a to 4e. The thickness and position of the rectangular skirt 5 defines the height of the peripheral wall 4 this may affect the accessibility for the pick-up of single rows from the matrix of pipetting tips in the carrier (see FIGS. 4a to 4c) or the detection of a missing row of pipette tips (see FIGS. 4d and 4e). The pipetting head 62 includes multiple collar adapters 70 which are lowered towards the collars 32 of the pipettes 2 by the pipetting robot for pick-up of the pipettes. The approach is halted when the collar adapters 70 of the pipetting head abut a mechanical stop such as the rectangular skirt 5 of the carrier 1 and a thin rectangular skirt 5 (FIGS. 4a and 4b) may provide sufficient access to the pipettes in the carrier for pick-up of a single row of pipettes while the adjacent collar adapters 70 do not contact the skirt 5 surrounding the carrier. If a hard stop is detected by the pipetting robot before effective pick-up of the pipettes from the carrier, then the pick-up of the tips may be jeopardized or the pick-up of the rows may damage the hardware of the pipetting robot, see FIG. 4c where thickness of the skirt 5 affects that the collar adapter 70 abuts the skirt 5 before the adjacent collar adapter 70 can catch the pipette tip 2 from the first row. The thickness of the rectangular skirt 5 may also affect the detection of a missing row of pipettes in the pipette tip carrier. FIG. 4d presents a pipette tip carrier 1 with a missing first row of pipettes 2 and the firmware of the pipetting robot can detect the missing row as the vertical position of the pipetting head 62 with the collar adapters 70 would normally detect an increase in vertical force required for the pick-up of the pipettes as the collar adapters 70 may need to elastically deform the rim of the pipette collar 32. The collar adapter that is adjacent to the collar adapter entering the passage 8 of the pipette carrier 1 does not abut the thin-walled rectangular skirt 5. A circumferential skirt 5 with a higher thickness as presented in FIG. 4e would result in a hard stop of the collar adapter 70 adjacent to the collar adapter entering the first row of passages 8 and the hard stop on the skirt would be detected before the firmware of the pipetting robot can detect the missing row. A thin-walled circumferential skirt 5 may therefore provide a versatile solution when used in a pipetting robot.

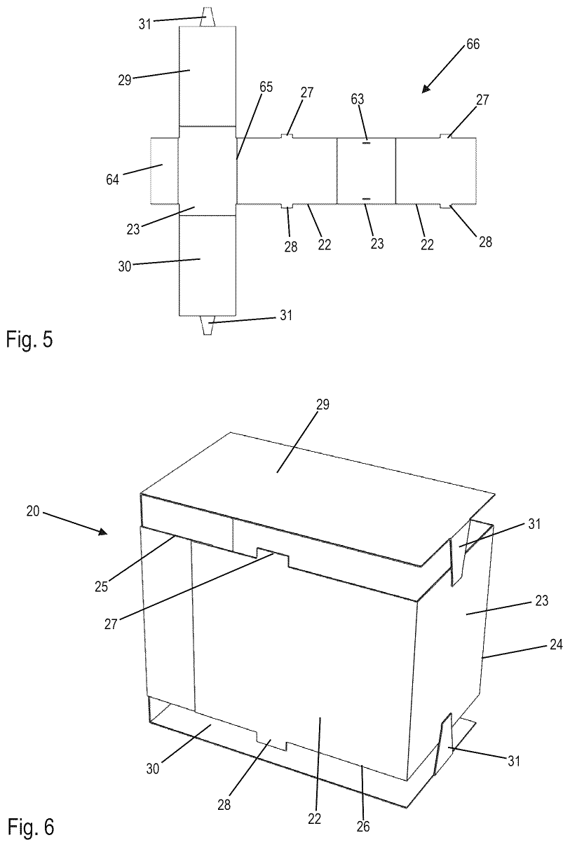

An example for a packaging 20 for the pipette tip carriers is presented in FIGS. 5 to 8. The packaging 20 is based on a foldable sheet 66 that is punched from a plate of a material such as cardboard, coated cardboard, plastic or a composite material. The foldable sheet 66 includes two longitudinal sides 22 connected by a transverse side 23. The longitudinal sides 22 each include two protrusions or flaps, a flap or protrusion 27 and a flap or protrusion 28 which, after the sheet 66 has been folded into a rectangular shaped box 24, extend from a top rim 25 and a bottom rim 26 of the packaging 20 (see FIG. 6). A top cover 29 and a bottom cover 30 is attached to one of the two transverse sides 23 and closure lids or closure flaps extend from the top cover and bottom cover respectively. Closure slits 63 are included in the other one of the two transverse sides 23 configured for engaging the closure lids 31. A closure flap 64 is attached to one of the transverse sides 23 for closing the rectangular box 24. Fold lines or predetermined folds are integrated in the foldable sheet 66, for example perforation lines or cutting lines 65 may be integrated in the foldable sheet 66. The two protrusions or flaps 27 or 28 may include barbed hooks for releasably fixating the pipette tip carrier to the packaging.

The sheet 66 may be folded in a rectangular shaped box 24 as presented in FIG. 6 providing the folded packaging 20. A top rim 25 and bottom rim 26 extend from the upper surface and lower surface of the longitudinal sides 22 and transverse sides 23 thereby providing a top opening and bottom opening that is accessible for insertion of two pipette tip carriers 1. The top and bottom openings are surrounded by the top rim and bottom rim, respectively. The protrusions or flaps 27, 28 extend from the top rim 25 and bottom rim 26, respectively. The top cover 29 and bottom cover 30 can be bent from a vertical orientation allowing access for the carriers towards the top and bottom rim for closing the packaging.

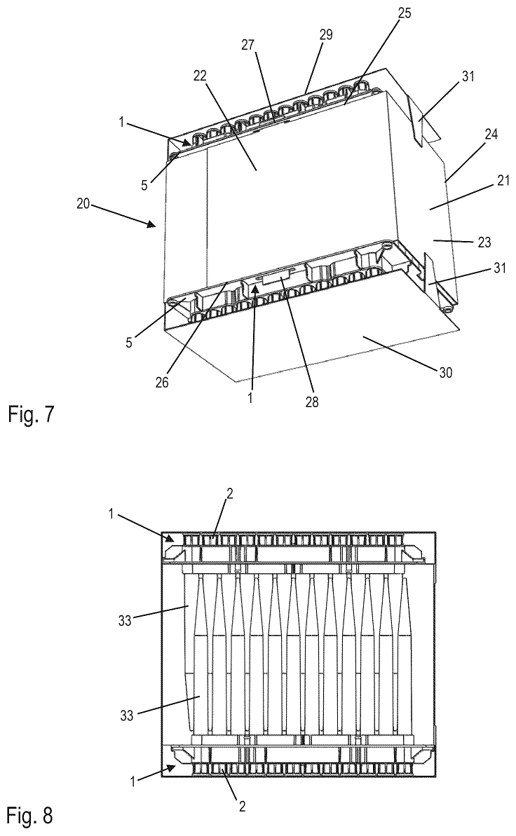

An assembly including the packaging 20 and two pipette tip carriers 1 is shown in FIG. 7. The two carriers 1 are each inserted with their respective bottom surfaces 17 of the skirt 5 facing towards the top rim 25 and bottom rim 26 of the packaging 20. The pipette tubes 33 that are releasably connected to the two pipette tip carriers are enclosed within the rectangular box 24 and the two flaps 27 extending from the top rim 25 engage the openings 11 of one of the two pipette tip carriers. The two flaps 28 extending from the bottom rim 26 engage the two openings 11 of the other one of the two pipette tip carriers. The optional barbed hooks on the flaps may provide a temporary fixation of the carrier to the packaging. The bottom surface 17 on the rectangular skirt 5 of each pipette tip carrier is supported by the top and bottom rim 25, 26 of the rectangular box 24 and the engagement between the protrusions 27, 28 and the openings 11 may prevent dislodgement between the rectangular skirt 5 of the carriers and the rectangular box 24. The packaging 20 is closed by folding the top cover 29 and bottom cover 30 such that the covers are aligned with the horizontal plane of the pipette tip carriers. The closure lids 31 are attached to transverse side 23 of the packaging using slits 63 (see FIG. 5). A longitudinal section through the packaging filled with two pipette tip carriers holding pipette tips is shown in FIG. 8. The pipette tubes 33 of each carrier are intermeshing for a space saving arrangement of the pipette tips 2. The two pipette tip carriers 1 may be removed from each side of the box after opening the closure lids 31 and tilting the top cover 29 and bottom cover 30 towards a vertical position.

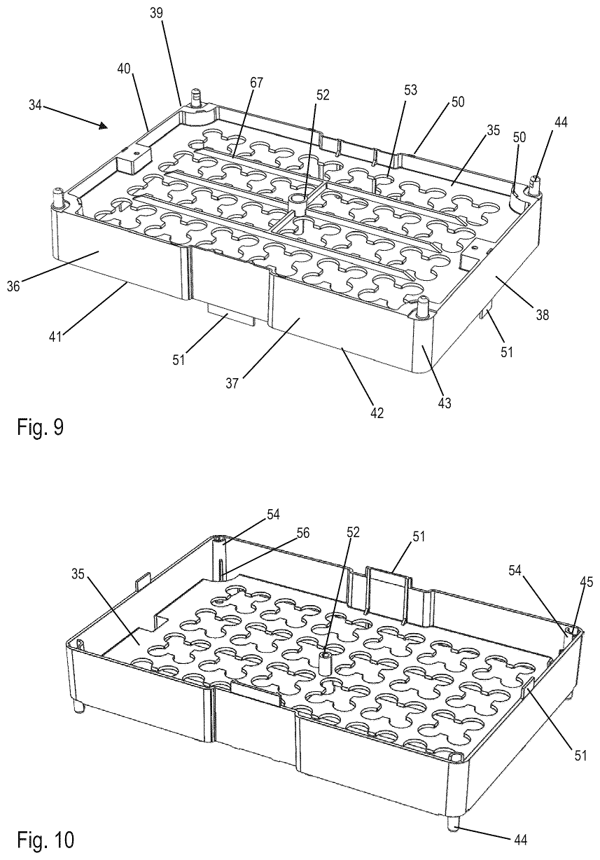

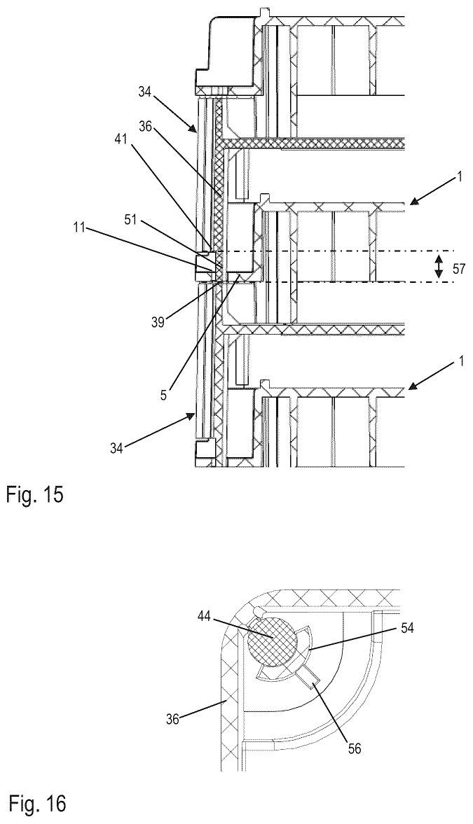

A rectangular shaped spacer 34 for stacking pipette tip carriers is presented in FIGS. 9 and 10. The spacer 34 includes a horizontal base surface 35 surrounded by a peripheral side wall 36 oriented essentially vertical with respect to the base surface 35. The base surface 35 includes semi-circular openings 53 with centers oriented to the same pattern as passages 8 in the pipette tip carrier. The semi-circular openings may intersect leading to a plurality of shamrock-shaped openings. The openings provide a passage for the pipetting tubes 33 of pipetting tips 2 engaging a pipette tip carrier positioned on top of the spacer 34 and prevent dislodgement of the collars 33 from a pipette tip carrier positioned below the spacer 34. The horizontal base surface 35 is strengthened with corrugated structures 67 such that material is added to the base surface where mechanically needed. The peripheral side wall 36 includes two longitudinal sides 37 and two transverse sides 38 providing an upper rim 40 and lower rim 42 which are oriented parallel to another. Ledges 50 project upwards from an upper surface 39 of the upper rim and protrusions 51 project downwards from a lower surface 41 of the lower rim 42. Protrusions 44 protrude upwards from the upper surface 39 in each corner of the rectangular shaped spacer 34. A projection 52 protrudes from the center of the rectangular shaped spacer 34 towards the upper rim 40 (FIG. 9) and protrudes from the center towards the lower rim 42 as well (FIG. 10). Load transfer elements 43 are located on each corner of the rectangular shaped spacer 34 which include the protrusion 44 and stop surfaces 45. Optionally, there are additional load transfer elements located between the corners of the spacer. Further details for the load transfer elements will be explained in FIGS. 14 and 15. The perspective bottom view in FIG. 10 further presents spring elements 54 that surround the stop surfaces 45 in each corner and the spring elements 54 are connected to the bottom surface of the horizontal base surface 35 and the free end of the spring element 54 may flex towards the center or towards the corner of the rectangular shaped spacer 34. The spring element 54 may be mechanically supported by a support rib 56 that protrudes from the bottom surface of the base 35. The load transfer elements 43 provide for the transfer of a vertical load from a spacer to a subjacent spacer whereas the spring elements 54 provide for a correct spacer-to-spacer alignment in a stack of spacers.

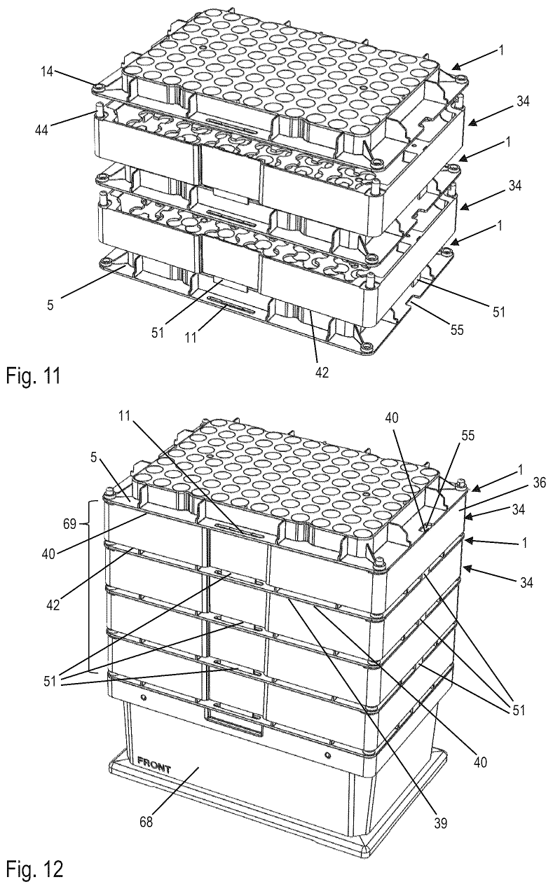

An exploded view of a stack of alternating spacers 34 and pipette tip carriers 1 is depicted in FIG. 11. Each pipette tip carrier 1 is positioned with the openings 14 on each corner onto the protrusions 44 on each corner of a subjacent spacer. The protrusions 51 protruding from the lower rim 42 of each spacer 34 are aligned with the cut outs 55 and the openings 11 in the rectangular skirt 5 of each pipette tip carrier 1 such that the openings 11 provide a passage for the protrusions, preferably without contacting or abutting the protrusions 51 thereby avoiding vertical load transfer from a spacer 34 to a pipette tip carrier 1 positioned below the spacer. The play in the horizontal plane between the protrusions 51 on the spacers and the cut outs 55 or the openings 11 on the carriers is sufficient to avoid direct contact.

The stacked pile 69 of spacers 34 and carriers 1 is shown in FIG. 12. The stack is placed on top of a pipette box 68 releasably holding the stack such that the stack or part of the stack may be removed by a gripper of a pipetting robot. The pipette box 68 may be fixated on a working table of the pipetting robot. Each pipette tip carrier 1 is placed on the upper surface 39 of the upper rim 40 of a subjacent spacer. Optionally, the carrier is supported by the ledges 50. The protrusions 51 protruding downwards from the lower rim of each spacer abut the upper surface 39 of a subjacent spacer either via the cut-outs 55 or via the openings 11 in the rectangular skirt 5 of each pipette tip carrier 1. The pipette tip carriers 1 are within a vertical space or gap between two spacers 34 and the vertical load applied to the pipette tip carrier 1 on top of the pile is transferred via the rectangular skirt 5 to the upper rim 40 of the first spacer 34 and the vertical load is subsequently transferred to the second spacer 34 via the load transfer elements 43 on each corner of the first spacer and/or via the protrusions 51 extending from the lower rim of the first spacer. The vertical load is finally transmitted to the worktable of the pipetting robot via the pipetting box 68. Details for the load transfer via the load transfer elements 43 are presented in FIG. 14 and details for the load transfer via the protrusions 51 are presented in FIG. 15.

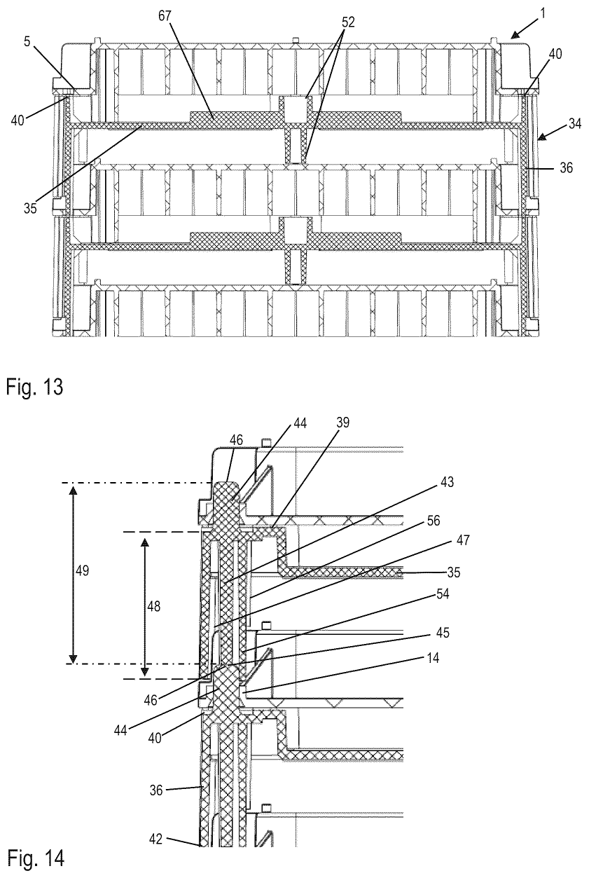

A longitudinal section for the stack is depicted in FIG. 13. The vertical load from the pipette tip carrier 1 on the top is transmitted via the rectangular skirt 5 to the upper rim 40 of the first spacer 34. The first spacer 34 includes the base surface 35 surrounded by the peripheral side wall 36 and the base surface 35 is strengthened by the corrugated structures 67 (see also FIG. 9). In case the pipette carrier 34 on top flexes or bends due to the vertical load, then the projections 52, which do not contact the subjacent or superjacent pipette tip carriers in a resting position, may additionally absorb the vertical loads thereby transferring a minor part of the load in the center from the pipette tip carrier on the top to the first spacer and, eventually, from the first spacer to the next pipette tip carrier.

Details for the load transfer elements are presented in FIG. 14. Starting from the bottom of the illustration: The spacer below the pipette tip carrier provides the protrusion 44 passing through the corner opening 14 of the pipette tip carrier 1 and the top surface 46 of the protrusion 44 abuts the stop surface 45 of the spacer positioned above the pipette tip carrier 1. There is a gap 57 (see FIG. 15) between the two spacers that is available for the pipette tip carrier preventing load transfer to the carrier. The vertical height of the peripheral wall 36 is defined by the distance 48 between the upper rim 40 and the lower rim 42 whereas the height of the load transfer element 43 is defined by the vertical distance 49 between the end of the protrusion 46 and the stop surface 45. The vertical distance 49 exceeds the height 48 of the peripheral wall 36 thereby leaving the gap below the lower rim 42 of each spacer that is available for the pipette tip carrier. Each pipette tip carrier may be placed on the upper rim 40 of a first spacer 34 and a second spacer may be placed on top of the first spacer, and the lower rim 42 of the second spacer will not contact the rectangular skirt 5 surrounding the pipette tip carrier.

Further details for the protrusions 51 of a spacer engaging the top surface of a subjacent spacer are shown in FIG. 15. The protrusions 51 projecting downwards from the longitudinal side of the lower surface 41 of a superjacent spacer 34 abut the upper surface 39 of a subjacent spacer 34 via the opening 11 in the pipette tip carrier 1. The abutment of the protrusions 51 projecting downwards from the transverse sides provide a comparable sectional view with the only difference in that the opening 11 is replaced by the cut-out 55.

The vertical loads applied to a pipette tip carrier may thus be transferred in a stack of spacers and carriers via the load transfer elements 43 on each corner, and/or via the protrusions 51 on the longitudinal sides of the spacer, and/or via the protrusions 51 on the transverse sides of the spacer for a direct spacer-to-spacer load transfer. Optionally a part of the vertical load is transmitted via the central projections 52 for spacer-to-carrier loading.

The spacer 34 includes spring elements 54 on each corner as presented in FIGS. 10, FIG. 15 and FIG. 16. When placing a spacer 34 onto another spacer carrying a pipette tip carrier, then the placement may be accompanied by a shift in the horizontal plane of the one spacer versus the another spacer. The play in the horizontal plane is compensated for or eliminated using the spring elements 54 located on each corner. The spring element 54 protrudes from the bottom surface of the horizontal base 35 towards the lower rim 42 and can flex along the diagonal of the rectangular shaped spacer towards the center or towards the corner of the peripheral wall 36. The spring element 54 of a spacer may have a semi-circular shape for at least partially surrounding the protrusion 44 protruding upwards from of a subjacent spacer. The spring elements of the top spacer on each corner can flex when engaging the protrusions 44 of a subjacent spacer and thereby self-center the spacer with respect to the subjacent spacer and compensate for horizontal misplacement or provide a barrier against twisting the stack of spacers. The twist barrier provides a resilient realignment force when torquing the top of the stack with respect to the bottom of the stack. Reliable pick-up of the pipettes from the carriers depends on the accuracy for the movements of the pipetting robot and on the dimensional tolerances for a stack of the spacers and the pipette tip carriers. The self-centering spring elements may thus reduce the stack-up of tolerances induced by the placements and handling of the spacers and carrier. The flexibility or resilience of the spring element may be tuned by the material used for the spring element 54 and/or the wall thickness of the spring elements and/or the use of a support rib 56 protruding along the back surface of the spring element 54 towards the end of the spring element. The spring element 54 may surround the stop surface 45 on each corner thereby acting as a guiding element guiding the post 44 of a subjacent spacer towards the stop surface of the spacer on top during spacer placement, see FIG. 16.

FIG. 15 furthermore presents the gap 57 between the two spacers 34 that is available for the pipette tip carrier 1 placed between the two spacers. The height of the gap 57 is defined by the difference between the length of the transfer element 49 and the vertical distance 48 between the upper and lower rim of the spacer as presented in FIG. 14. FIG. 14 furthermore presents the spring elements 54 in the longitudinal sectional view engaging the protrusion 44 of a subjacent spacer. The spring elements 54 for guiding and aligning the spacers act during pile-up or stacking of the spacers and pipette tip carriers onto each other, this operational step in the laboratory automation procedure is done before starting the liquid handling procedure with the pick-up, and therewith vertical loading of the stacks. The spacer presented above in combination with the trays therefore allows for a separation of the correct alignment during stacking and an effective transfer of the vertical loads during liquid handling and this in combination with spacers and pipette tip carriers that require less material during manufacturing and have a lower carbon footprint.

The mere fact that certain elements or steps are recited in distinct claims shall not preclude the existence of further meaningful combinations of these elements or steps.

LIST OF REFERENCE SIGNS

| | |
|---|---|
| 1 | Rectangular shaped pipette tip carrier |
| 2 | Disposable pipetting tip |
| 3 | Rectangular shaped top plate |
| 4 | Peripheral wall |
| 5 | Rectangular skirt |
| 6 | Hollow cylinder |
| 7 | Circular opening |
| 8 | Passage |
| 9 | Ribs, connecting ribs |
| 10 | Skirt ribs |
| 11 | Opening |
| 12 | Longitudinal side |
| 13 | Transverse side |
| 14 | Opening, corner opening |
| 15 | Corner rib |
| 16 | Corner peripheral wall |
| 17 | Bottom surface |
| 18 | Bottom wall |
| 19 | Guiding member |
| 20 | Packaging |
| 21 | Peripheral side wall |
| 22 | Longitudinal side |
| 23 | Transverse side |
| 24 | Rectangular shaped box |
| 25 | Top rim |
| 26 | Bottom rim |
| 27 | Protrusion, flap extending from top rim |
| 28 | Protrusion, flap extending from bottom rim |
| 29 | Top cover |
| 30 | Bottom Cover |
| 31 | Closure lid |
| 32 | Pipette collar |
| 33 | Pipette tube |
| 34 | Rectangular spacer |
| 35 | Horizontal base surface |
| 36 | Peripheral side wall |
| 37 | Longitudinal side |
| 38 | Transverse side |
| 39 | Upper surface |
| 40 | Upper rim |
| 41 | Lower surface |
| 42 | Lower rim |
| 43 | Load transfer element |
| 44 | Protrusion |
| 45 | Stop surface |
| 46 | End of protrusion |
| 47 | Rib |
| 48 | Vertical distance upper-lower rim |
| 49 | Length load transfer element |
| 50 | Ledge |
| 51 | Protrusion |
| 52 | Projection |
| 53 | Opening |
| 54 | Spring element |
| 55 | Cut-out |
| 56 | Support rib |
| 57 | Gap |
| 58 | Labelling section |
| 59 | Indentions |
| 60 | Ridge |
| 61 | Gripper pipetting robot |
| 62 | Pipetting head |
| 63 | Slits |
| 64 | Closure flap |
| 65 | Predetermined folding line; predetermined fold |
| 66 | Foldable sheet |
| 67 | Corrugated structure |
| 69 | Pipette box |
| 70 | Collar adapter |
| 71 | Reinforcement rib |

1. A rectangular shaped pipette tip carrier for holding a plurality of disposable tips for use in a pipetting apparatus, the pipette tip carrier comprising:
a rectangular shaped top plate defining a horizontal plane,
a peripheral wall surrounding the top plate and connecting the top plate to a rectangular skirt vertically distanced from the top plate and surrounding the peripheral wall,
a plurality of vertically oriented hollow cylinders extending from the top plate towards the bottom surface of the rectangular skirt,
a matrix of circular openings in the top plate which are aligned with the plurality of hollow cylinders thereby defining a matrix of passages through the pipette tip carrier for detachably holding and guiding the disposable pipette tips,
a plurality of ribs located between and connecting the hollow cylinders to another,
a plurality of skirt ribs connecting the top surface of the rectangular skirt to the peripheral wall,
wherein at least one opening in the longitudinal side or the transverse side of the rectangular skirt providing a passage for a protrusion of a packaging for the pipette tip carrier, or a passage for a protrusion of a spacer configured to be positioned on top of the pipette tip carrier.

2. The rectangular shaped pipette lip carrier according to claim 1, further comprising openings at each corner of the rectangular skirt providing passages for complementary protrusions on a spacer configured to be positioned below the pipette tip carrier.

3. The rectangular shaped pipette tip carrier according to claim 2, further comprising corner ribs connecting the openings to the corners of the peripheral wall.

4. The rectangular shaped pipette tip carrier according to claim 3, wherein the passages provide a matrix of rows and columns evenly distributed across the rectangular shaped top plate according to an ANSI/SLAS standard.

5. The rectangular shaped pipette tip carrier according to claim 1, wherein the center of the rectangular shaped top plate is on top of the center of the rectangular skirt for a mirror symmetric arrangement of the passages within the pipette tip carrier.

6. The rectangular shaped pipette tip carrier according to claim 1, wherein the center of the rectangular shaped top plate is shifted in the horizontal plane with respect to the center of the rectangular skirt.

7. The rectangular shaped pipette tip carrier according to claim 5, wherein the end of the hollow cylinders is flush with the bottom surface of the rectangular skirt.

8. The rectangular shaped pipette tip carrier according to claim 5, wherein a bottom wall extends vertically from the bottom surface of the rectangular skirt.

9. The rectangular shaped pipette tip carrier according to claim 8, wherein the bottom wall comprises at least one snap-fit connector or guiding member.

10. The rectangular shaped pipette tip carrier according to claim 5, wherein the rectangular skirt further comprises at least one cut-out in the longitudinal side or the transverse side of the rectangular skirt not having the at least one opening.

11. The rectangular shaped pipette tip carrier according to claim 5, wherein the at least one opening has a rectangular shape.

12. The rectangular shaped pipette tip carrier according to claim 5, wherein the rectangular skirt comprises two opposing openings positioned on the two longitudinal sides, or two opposing openings positioned on the two transverse sides wherein the two opposing openings provide two passages for two protrusions of a packaging for the pipette tip carrier or for two protrusions of a spacer configured to be positioned on top of the pipette tip carrier.

13. The rectangular shaped pipette tip carrier according to claim 5, which is manufactured by injection molding of a polymer.

14. The rectangular shaped pipette tip carrier according to claim 13, wherein the polymer is a recycled polymer or a biopolymer.

15. The rectangular shaped pipette tip carrier according to claim 14, wherein the polymer selected from polystyrene (PS), polycarbonate (PC), high impact polystyrene (HIPS), polyethylene (PE) or polypropylene (PP).

16. A rectangular shaped pipette tip carrier for holding a plurality of disposable tips for use in a pipetting apparatus, the pipette tip carrier comprising:
a rectangular shaped top plate defining a horizontal plane,
a peripheral wall surrounding the top plate and connecting the top plate to a rectangular skirt vertically distanced from the top plate and surrounding the peripheral wall,
a plurality of vertically oriented hollow cylinders extending from the top plate towards the bottom surface of the rectangular skirt,
a matrix of circular openings in the top plate which are aligned with the plurality of hollow cylinders thereby defining a matrix of passages through the pipette tip carrier for detachably holding and guiding the disposable pipette tips,
a plurality of ribs located between and connecting the hollow cylinders to another,
a plurality of skirt ribs connecting the top surface of the rectangular skirt to the peripheral wall,
wherein at least one opening in the longitudinal side or the transverse side of the rectangular skirt providing a passage for a protrusion of a packaging for the pipette tip carrier, or a passage for a protrusion of a spacer configured to be positioned on top of the pipette tip carrier, wherein the rectangular skirt further comprises at least one cut-out in the longitudinal side or the transverse side of the rectangular skirt not having the at least one opening.

17. The rectangular shaped pipette tip carrier according to claim 16, further comprising openings at each corner of the rectangular skirt providing passages for complementary protrusions on a spacer configured to be positioned below the pipette tip carrier.

18. The rectangular shaped pipette tip carrier according to claim 17, wherein the center of the rectangular shaped top plate is shifted in the horizontal plane with respect to the center of the rectangular skirt.

19. The rectangular shaped pipette tip carrier according to claim 18, wherein a bottom wall extends vertically from the bottom surface of the rectangular skirt.

20. The rectangular shaped pipette tip carrier according to claim 19, wherein the at least one opening has a rectangular shape.
